(19) United States
(12) Patent Application Publication
(10) Pub. No.: US 2009/0187399 A1
(43) Pub. Date: Jul. 23, 2009

(54) Using Homophones and Near-Homophones to Improve Methods of Computer Text Entry for Chinese Characters

(76) Inventor: Robert B. O'Dell, (US)

Correspondence Address: Robert B. O'Dell, 602 Calmar Avenue, Oakland, CA, 94610, US

(21) Appl. No.: 12/017,960

(22) Filed: Jan. 22, 2008

(51) Int. Cl. G06F 17/20; G06F 17/28

(52) U.S. Cl. 704/8; 704/3; 704/E11.001

(57) ABSTRACT

The invention allows phonetic text input without any knowledge of phonetics. As an assist to the user of computer text entry systems, the invention makes possible an alternative method of Chinese character entry by entering a Chinese character assumed by the user to be a homophone of the character the user desires to enter. Entry methods for such homophone alternative entry include non-phonetic entry of Chinese characters using keyboard stroke input and single stroke, cursive and semi-cursive entry on an electronic surface. Direct correction of some misspellings of Chinese characters during phonetic entry also is made possible. The invention is not only helpful for entry of difficult Chinese characters but also provides an approach to the use of supplementing input methods for most if not all written languages.

### FIELD OF THE INVENTION

Computer input of Chinese text, and, more particularly, methods of alternative input of Chinese characters.

### BACKGROUND OF THE INVENTION

The average student in China is said to know about 3500 characters when leaving secondary school. For those educated beyond the secondary school level the numbers are said to be significantly higher. But for various reasons, many people, even the best educated, find that sometimes they can not call to mind the exact look of a character even though they recognize it easily when they see it in print.

Not surprisingly, then, a continuing problem for even the most competent users of computer text-entry methods for Chinese is that they sometimes find themselves at a loss when trying to enter a character with non-phonetic entry methods, including keyboard entry and handwriting on an electronic pad or screen. Another barrier to such non-phonetic character entry is that the user sometimes forgets the standard stroke order of a character, which is a problem not only for keyboard entry, but also for the use of handwriting input on an electronic pad or screen. And, since handwriting recognition is based on statistical data gained from a sample of possible users, the user of handwriting recognition programs not only can have the problem of not remembering the look of the character or the stroke order, but also may find that the computer does not recognize the entry simply because of the user's handwriting style.

Partly because of such problems with non-phonetic character entry, phonetic keyboard entry remains the character entry method most commonly used.

But neither are phonetic entry methods immune to character entry problems. Pinyin, a method of using Western alphabet to spell out the sounds of Chinese characters, is taught in virtually all of China's elementary schools. But many fail to master Pinyin so completely as to have great confidence in its use. Pinyin spelling is sometimes forgotten just when a user needs to input the character. This is especially true for those whose native tongue is not Beijing Mandarin (referred to also as Putonghua—‘the common language’, which is the standard taught in the schools) but another dialect of Chinese. It can also create difficulties for those whose native language is Mandarin but whose local pronunciation differs from Beijing Mandarin (the Putonghua standard) as much as does that between speakers of U.S. English in New England and Alabama. Another problem for phonetic character entry is that neither Pinyin nor any other phonetic input method can be used to enter characters which the user cannot pronounce, a problem that can result both with unfamiliar characters as well as from common variations in pronunciation.

When the user's pronunciation of the needed character is not standard, or the user needs to input an unfamiliar character the difficulty of phonetic input often causes the user to turn to non-phonetic entry of the character. But, while pronunciation is a problem for phonetic entry, non-phonetic entry also can present problems for the user, as noted heretofore. Non-phonetic keyboard input, for example, also requires knowledge of at least the first few strokes and stroke order. It is as though no English word could be entered into a computer unless at least the first few letters are correct. Various efforts—such as allowing variations in stroke order and displaying possible alternative characters with the same beginning—are only of modest help, and of no help at all where the user can not remember the look of the character, until it is displayed. And, as noted heretofore, writing the character on an electronic pad not only requires knowing the exact character image, but is also a test of penmanship, if the user's writing is to be correctly interpreted by the handwriting software.

Many input methods of Chinese character input have a steep learning curve—which varies for each user—and all entry methods are imperfect. What is needed is an adjunct for non-phonetic methods of text entry of Chinese characters that is a simple alternative method of non-phonetic text input which will allow a user to more easily input characters that the user can neither spell nor pronounce in standard Putonghua, and/or cannot visualize, and/or has forgotten the stroke order, and/or has difficulty writing clearly on an electronic pad. Not only would this provide help to users of phonetic text input, it also would enhance the appeal of non-phonetic character input. Since the beginning of computer entry of Chinese characters several decades ago, difficulty with character image recall has been a significant barrier to widespread adoption of non-phonetic input methods, and continues to be so today.

### SUMMARY OF THE INVENTION

The text entry method disclosed herein allows the user to base Chinese character entry on the pronunciation of the character without requiring any knowledge of phonetics. Rather than using direct phonetic or non-phonetic keyboard or manually written entry of the desired Chinese character, a user can input the desired Chinese character by non-phonetic entry of a character that is a homophone of the desired character.

After entry of an alternative homophone character causes the display of the entered alternative homophone character, the user selects the entered alternative homophone character then presses a designated homophone entry key or, if writing the character manually, the user makes a designated movement with the writing instrument, which will indicate selection of a homophone entry. The result of the indication that the entry was alternative homophone entry then causes the display of all characters with the same pronunciation as the entered alternative homophone character, including the desired character whose entry the user was unable to achieve in the usual way. The user then selects the desired character from among the homophones displayed and sends it to the text line. Except for the indication that the entry is alternative homophone entry rather than the usual entry of a desired character, the entry of the alternative homophone character is the same as it would be if it were being entered directly as with any desired character. In an alternative embodiment the indication of alternative homophone entry can be made prior to beginning entry of the alternative homophone, rather than after entry has identified the alternative homophone.

For Chinese language input, homophones are considered herein to be those characters with identical Pinyin spellings and pronounced with the same tone. But it is not necessary that the user be correct in the assumption that the entered alternative character is actually a homophone of the desired character. If the desired character is not displayed after the user indicates that the entry was alternative homophone entry, the user then asks for a display of near-homophones—characters that are spelled the same in Pinyin as the entered homophone, but have a different standard Putonghua pronunciation. If the desired character is not displayed as a homophone or near-homophone, groups of ‘non-standard-homophones’ also are accessible to the user. These are characters which the user assumes are pronounced the same as the desired character but are not considered to be pronounced the same in standard Putonghua, and also have a different Putonghua spelling than does the desired character; these include, for example, characters spelled Zhi and Zi in Pinyin—characters that seem to some regional groups of users to be homophones, but which are not homophones in Putonghua.

In another embodiment the invention uses homophones of Chinese dialects other than Mandarin, including Wu, Yue (Cantonese), Xiang, Min, Hakka and Gan. A user whose native tongue is Yue and who does not have complete confidence in his Putonghua uses Yue homophones by following an alternative homophone character entry with an indication that it was not a Putonghua homophone that was entered but a Yue homophone, and Yue homophones will be displayed for selection.

The invention provides an alternative character entry method as a supplement to the various methods of character entry, but it is also available as a primary means of entry for some or all character entry. In order to increase text entry speed and reduce frustration, an experienced user may decide to use alternative homophone entry as the usual non-phonetic entry method for characters which the user finds slow or difficult to input.

The text entry method is also useful for direct correction of some phonetic misspellings of Chinese characters.

The invention is applicable to Japanese and Korean and to the use of both Chinese traditional and simplified characters, as well as to alphabetic languages. User access to homophones, near-homophones, non-standard homophones and words that might sound somewhat similar but are spelled differently are helpful to users of alphabetic languages who have frequent spelling problems.

### A BRIEF DESCRIPTION OF THE DRAWINGS

FIG. 1 is a block diagram of a computer apparatus for utilizing an encoding system using input of Putonghua homophones, near-homophones, and non-standard homophones to access Chinese characters as an alternative to regular entry of Chinese characters in accordance with the invention.

FIG. 2 is a logic flow diagram showing input of Putonghua homophones, near-homophones and non-standard homophones to access Chinese characters as an alternative to regular entry of Chinese characters in accordance with the invention.

FIG. 3 is a drawing of a mobile phone display and reduced keyboard used for stroke entry of Chinese characters including alternative entry of Putonghua homophones, near-homophones and non-standard homophones, showing stroke categories on five of its keys and showing other keys used for alternative entry in accordance with the invention.

FIG. 4 is an example of homophones displayed after alternative homophone entry of any of the displayed twelve homophone Chinese characters, each of which has the same pronunciation, (rendered in Pinyin as mu) and any character of which can be entered as a homophone of any of the other characters displayed in accordance with the invention.

FIG. 5 is an example of homophones and near-homophones displayed after entry of any one of the displayed eighteen characters, followed by an indication that the character has been entered as a near-homophone in accordance with the invention.

### DETAILED DESCRIPTION OF THE INVENTION

Chinese characters are considered to consist of single syllables. Their pronunciation is made up of an initial sound and a final sound. For example the character for tree [symbol] , pronounced mu, has an initial ‘m’ sound and a final ‘ù’ sound. In Putonghua a character is said to be pronounced with one of four tones: flat, rising, falling then rising, or falling. For the Pinyin letter u, for example, these tones are represented respectively as ū, ú, \check{u}, and ù.

A Chinese-character homophone is referred to herein as a character that has exactly the same standard Putonghua pronunciation—including the same tone—as one or more other characters. Characters referred to herein as ‘near-homophones’ are characters rendered in Pinyin with identical spellings, but pronounced in Putonghua with different tones. The reference herein to ‘non-standard homophones’ is to characters whose standard Putonghua pronunciation is incorrectly assumed by some users or groups of users to be the same as that of one or more other characters whose Pinyin spellings are different from that of the incorrectly assumed homophone. But a user of the invention need not be concerned with such distinctions as homophones, near homophones and non-standard homophones. If, in fact, the user has input a near homophone, thinking it is a homophone, he still will be able to find the desired character.

The invention allows the user to base character entry on the pronunciation of the character without requiring a knowledge of phonetics, thereby providing an alternative method of entry which is used as a supplement to any method of Chinese text input. Rather than using direct methods of non-phonetic character entry, including keyboard and stroke, cursive or semi-cursive written entry of the desired Chinese character, the user enters the desired Chinese character by entry of a character that is a homophone, near-homophone or non-standard homophone of the desired character. This can be a great help when the user of a Chinese character non-phonetic input method has forgotten for the moment the exact appearance of the desired character's image, or is confused—at least momentarily—about the desired character's stroke order. It is also helpful as an alternative for phonetic character input—including Pinyin input—when the user is uncertain of the correct phonetic spelling and would like to use a non-phonetic method to input the character, but cannot remember the exact image of the desired character. The invention is also useful for simply checking the proper Putonghua pronunciation of a character by inputting the character non-phonetically and asking for a display of its homophones; this can be especially helpful for checking pronunciation of rarely used characters or of a character which is new to the user.

The invention creates the opportunity of non-phonetic input of a more familiar character rather than the desired character with the result that the computer displays all characters pronounced like the desired character so that the user can enter a desired character without having to input the desired character. In an English analogy a user could input the word ‘threw’ if he could not remember how to spell ‘through’, and have both spellings displayed for selection after entry of the word ‘threw’ and a request for a display of homophones of the word ‘threw’.

Although Chinese has far fewer homophones than Japanese Kanji, Chinese still has a great many. Over 90% of the 5,000 characters most commonly used in Chinese share their Mandarin pronunciation with—on average—three or four other characters within that group of 5,000, and with many more within more complete sets of Chinese characters, which are said to number several tens of thousands.

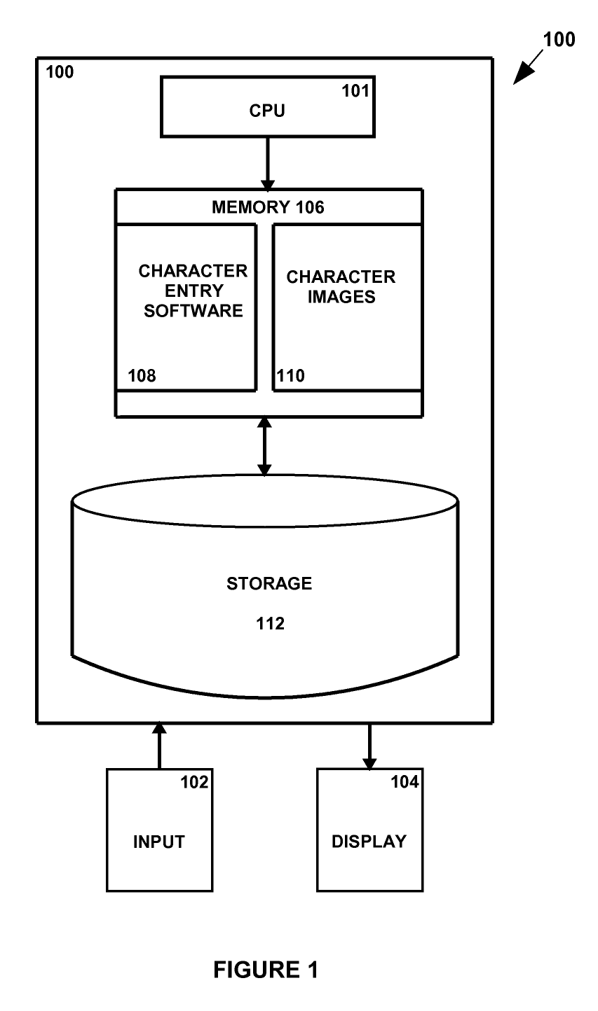

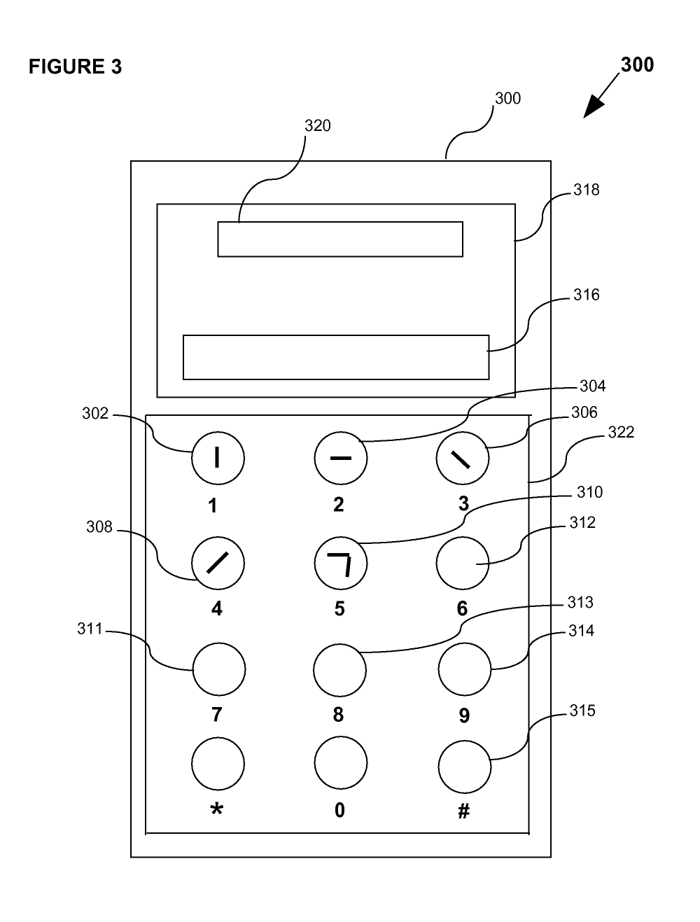

FIG. 1 shows a block diagram of a computer implementation which allows entry of homophones, near-homophones, and non-standard homophones as an alternative method of entry of a desired character. The preferred embodiment of the invention uses the computer implementation of FIG. 1 with a known non-phonetic Chinese character input method, that of the stroke-input method of O'Dell, U.S. Pat. No. 5,109,352—hereinafter referred to as O'Dell. The O'Dell stroke-input method is used for calling out the display of a desired character using a reduced keyboard which, as seen in FIG. 1, assigns each of five different keys to a separate category of the Chinese-government-designated five stroke categories: vertical strokes, horizontal strokes, strokes drawn down to the right, strokes drawn down to the left, and strokes with one or more ‘turning points’ or ‘corners’. These five categories embrace all strokes used to make Chinese characters. Such a configuration of stroke category keys is seen in FIG. 3 as keys 1, 2, 3, 4 and 5, which are designated respectively as 302, 304, 306, 308, and 310.

The method of O'Dell is illustrated as follows: In order to input the character for ‘tree’ [symbol] using the method of O'Dell with reduced keyboard 322 of mobile phone 300 in FIG. 3, the user presses the appropriate stroke category keys in the same sequence with which the strokes are laid down in the traditional taught order when making the character with pen, pencil or brush. To call out the display of the character for ‘tree’ [symbol] , the user, needing to enter the key press sequence 21436, presses 304 (the 2 key) for the first (horizontal) stroke, then 302 (the 1 key) for the second (vertical) stroke, 308 (the 4 key) for the third (down-left) stroke, 306 (the 3 key) for the fourth (down-right) last stroke, and finishes with a press of (the 6 key) 312 to indicate that input is complete. (This last key-press (312) is necessary because the character for ‘tree’ [symbol] is the beginning element of other, more complex characters, and other characters which also begin with the same four-key-press sequence.) The input string sequence is listed among the input strings in the database and results from the sequence of key presses, which for ‘tree’ [symbol] is 21436.

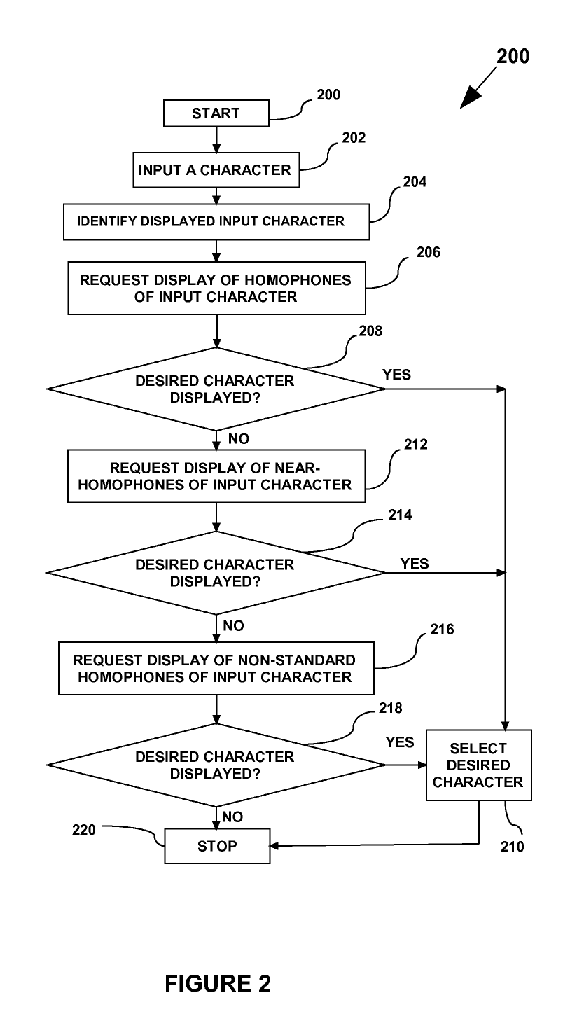

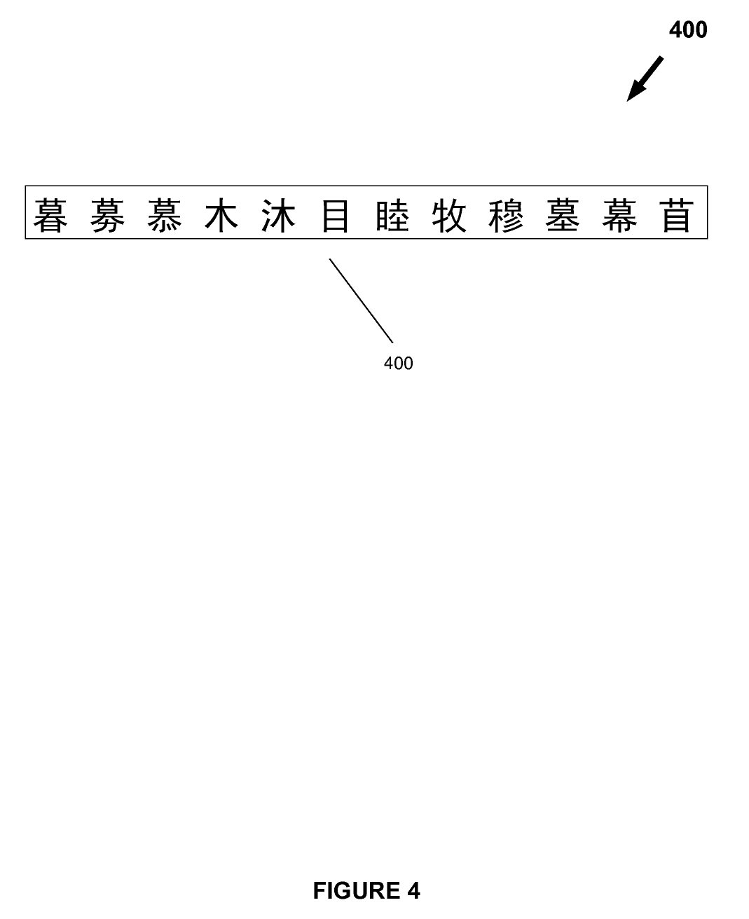

In an illustrative example of the preferred stroke-input embodiment, homophones are used as alternative input to stroke input of the desired character on the reduced keyboard 322 of mobile phone 300, which includes the computer configuration of FIG. 1, with Computer 100, CPU 101, Input 102, Display 104, and Memory 106 with Character Entry Software 108 and Character Images 110 which are stored in Storage 112. The user desires to input the character [symbol] , rendered in Pinyin as mù. Unable to recall the character's image [symbol] or, perhaps uncertain of its stroke sequence or unable to identify the needed stroke categories, the user decides to input the Chinese character for ‘tree’ [symbol] , since the two characters have identical pronunciations: mù. Referring to FIG. 2, the user starts the homophone input process at 200. In step 202, the user enters the character for ‘tree’ [symbol] by pressing keys of reduced keyboard 322, which functions in the embodiment as input 102, in traditional stroke-order sequence the stroke categories of the strokes of character [symbol] . The user then presses the end of character key—key ‘6’—after stroke-category entry is complete. CPU 101 uses character entry software 108 in memory 106 to recognize that the input is for the character for ‘tree’ [symbol] and selects the character image for ‘tree’ from the character images 110 in memory 106 that had been stored along with character entry software 108 in storage 112. Then, at step 204, the image [symbol] is sent for display at 316 on display screen 318, which, in the embodiment, functions as display 104. Then, instead of using the usual key press that would, in the course of regular input, send the character [symbol] to text line 320 the user presses the ‘7’ key 311 in step 206, which causes the display 104 to display in area 316 on display screen 318 all the available homophones 400 (seen in FIG. 4) of the character for ‘tree’ [symbol] . If, after pressing the ‘7’ key 311, the user sees in step 208 that the desired character is displayed at 316, then, in step 210, the user selects desired character [symbol] from among the homophones displayed at 316, whereupon character [symbol] is sent to the text line 320 and the process stops at 220. If there are more homophones than the display area 316 for character selection allows and the user does not find the desired character in the first display, the user presses the ‘#’ key 315 to call for more homophone characters to be displayed.

For any of the homophones in the group of characters pronounced the same as the desired character, the input string (the sequence of key-presses) that calls out the display of any one of the homophones for [symbol] is the same as the input string used to enter that same homophone character normally, when its input is not homophone input. It is the press of the ‘7’ key, 311, in step 206 that indicates that the input was done not to add—in the illustrative example—the character [symbol] to the text line, but in order to display and select one of its homophones, which was the actual desired character [symbol] .

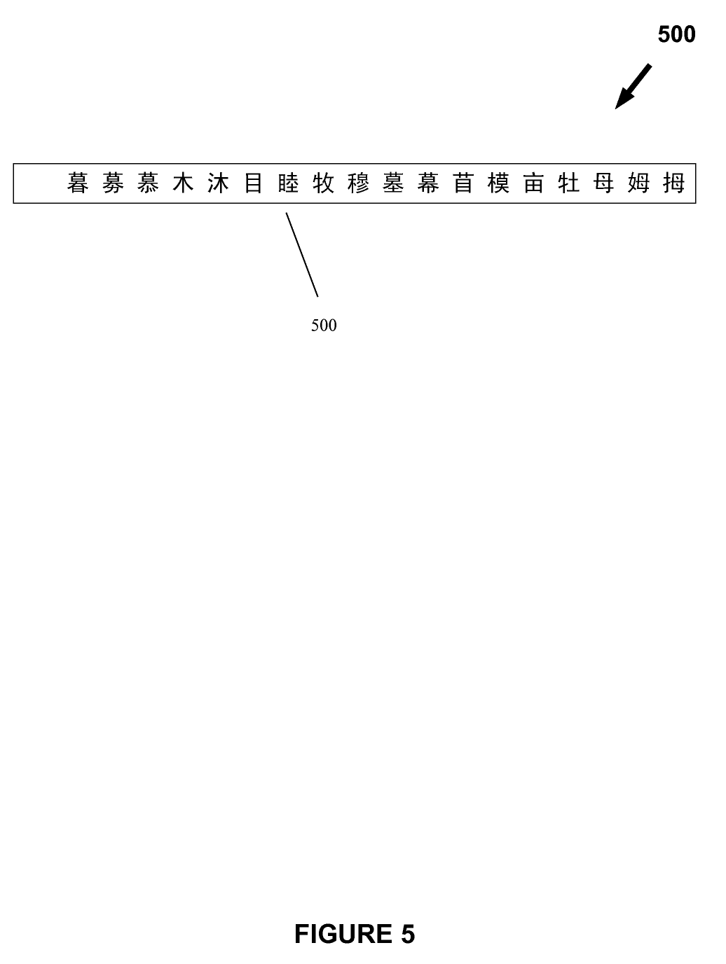

Another feature of the preferred embodiment allows the user to input ‘near-homophones’, characters referred to herein as characters with similar but not exactly the same standard pronunciation in Putonghua and which begin with the same initial sound and are followed by the same final sound and are, therefore spelled the same but are spoken with different tones. This is helpful when the user is uncertain of the standard Putonghua pronunciation or can not think of a character that is an exact homophone of the desired character, but does know a character with the same Pinyin spelling. In an illustrative example, the user wants to enter the character [symbol] , rendered in Pinyin as “m\check{u}”, and can not remember the character image or an exact homophone, but knows that its pronunciation is very similar to that of [symbol] or that it is spelled with the same letters in Pinyin, or perhaps mistakenly thinks that it is an exact homophone of the character [symbol] . After the user enters [symbol] , the user finds in 208 that the desired character [symbol] is not among the homophone characters displayed at 316. So, in step 212 the user presses the ‘7’ key, 311, again, causing a display at 316 of ‘near-homophones’ 500 (seen in FIG. 5), whose Pinyin spelling is the same as the desired character, [symbol] but whose tone may be the same as the desired character m\check{u} (falling, then rising) or different, such as is the case for [symbol] : mù (falling). The character [symbol] is now displayed for selection in 316 among other near-homophone candidates. It is determined in step 214 that the desired character is displayed after this second press of the ‘7’ key 311, and the character is selected in step 210 and sent to text line 320.

In another embodiment, no distinction is made between homophones and near-homophones. This creates a larger group of ‘homophones’ from which the user must choose, but does not require a second press of the ‘7’ key.

One more feature of the preferred embodiment allows the user to be wrong in thinking that the desired character is a homophone or near-homophone of the character input. If it is determined in step 214 that the desired character is not displayed after this second press of the ‘7’ key 311, the user requests a display of ‘non-standard homophones’. Pressing the 7 key again, at step 216, accesses ‘non-standard homophones’, which can compensate for the user's pronunciation uncertainty caused by the similarity of initial or final sounds. For example, if the user enters [symbol] (rendered in Putonghua as ‘pā’) in step 202 thinking it to be a homophone of the character [symbol] , which the user incorrectly assumes is pronounced ‘bā’ in Putonghua, the user will not see at step 208 that the desired character [symbol] is displayed. Nor will the user see the desired character displayed at step 214, since the desired character is not a near-homophone either, that is to say that it is not spelled the same in Pinyin as the desired character. So, in step 216 the user presses the ‘7’ key, 311, and all the characters pronounced ‘bā’ are displayed, including the character [symbol] . If there are more assumed homophones than the display area 316 for character selection allows and the user does not find the desired character in the first display, the user presses the # key 315 to call for more homophone characters to be displayed. If after pressing the ‘7’ key, 311, in step 216, the user sees in step 218 that the desired character is displayed at 316, then, in step 210, the user selects the desired character [symbol] from among the homophones displayed at 316, whereupon character [symbol] is sent to the text line 320 and the process stops at 220. If the desired character is not displayed at step 218, the process stops at 220. Designation of ‘non-standard homophones’ in this embodiment is based on common mispronunciations of standard Putonghua.

Another aspect of the ‘non-standard homophone’ input feature of the preferred embodiment allows the user to input non-standard-homophone characters as an aid to users having difficulty with standard Putonghua pronunciation. While such pronunciation difficulties can be individual, it also can be the result of regional differences in the pronunciation of Mandarin. One group of non-standard homophones includes characters whose pronunciation among some regions of China is, for some characters, commonly at predictable variance with that of Putonghua. Putonghua has initial sounds of ‘zh’, ‘sh’, or ‘ch’, for some characters, as well as ‘z’, ‘s’, or ‘c’ for other characters. But many speakers whose native dialect is not Beijing Mandarin ordinarily can not make such a distinction, assuming only ‘z’, ‘s’, and ‘c’ initial sounds. Such speakers using this embodiment will be able to display homophones which include both initial sounds by pressing the ‘7’ key, 311, in step 216, just as in the illustrative example of non-standard homophone input given heretofore. In another embodiment, users can access regionally-based non-standard homophones by pressing the 8 key, 313, in step 206, rather than the ‘7’ key, 311, immediately upon identification of the displayed input character.

In another embodiment, non-standard and near homophones can be displayed together.

Homophones, near-homophones and non-standard homophones are ranked on display in the preferred embodiment according to their frequency of usage, from most frequent to least frequent. In familiar phrases or in words of more than one character, the display and rankings are altered according to characters that preceded the desired character in the word or phrase, since some characters never follow another in the same word or familiar phrase, and those that do follow will vary in the frequency with which they are used to follow the previous character; such changed rankings are known to those skilled in the art.

In another embodiment, homophones, near homophones and non-standard homophones are ranked on display inversely according to their frequency of usage from least frequent to most frequent, since the less frequently used characters might be more pertinent for some users. In yet another embodiment, using techniques familiar to those skilled in the art, the ranking is constantly altered to reflect the frequency of usage of the user of the input device by keeping a record in the device of a user's character input.

There are some characters which have more than one accepted pronunciation in Putonghua. In some cases the pronunciations differ only in tone. But in a few cases, the pronunciations vary in the initial and/or final sounds. For example the character [symbol] is pronounced ‘ba’ when used to mean ‘hold on to’ but ‘p’ when used to mean ‘rake up’ or ‘stew’. So, in another feature of the preferred embodiment, entry of characters that are homophones of either pronunciation will, after a press of the 7 key to indicate homophone entry, bring a display of characters that includes both pronunciations.

In another keyboard embodiment, characters are entered using a full keyboard, rather than with a reduced keyboard.

In another hardware embodiment, characters are entered not via a keyboard but by use of electronic devices for detecting and tracking movement, including the movements of a stylus, finger or electronic pen to make individual strokes or cursive or semi-cursive movement to construct a Chinese character. The indication that the entry is a homophone of the desired character is accomplished by pressing a soft key on the electronic surface. Alternatively, in another embodiment, the indication that the entry is a homophone of the desired character is done by a movement with the writing device that is different from movements made to enter strokes.

As understood by those skilled in the art, it is also possible in another embodiment to allow the user to precede alternative homophone input with the indication that the input will be alternative homophone input, rather than to make the indication following input.

Besides helping those users who can not remember the look of a needed character, the invention relieves yet a further complication for those who want to input Chinese. While the illustrations used heretofore are concerned with Putonghua (Beijing Mandarin), it is also useful to apply the method to homophones from Chinese dialects other than Beijing Mandarin, including Wu, Yue (Cantonese), Xiang, Min, Hakka and Gan. Since the various dialects all use the same characters, non-phonetic input of a character is unaffected by the spoken dialect, and, consequently, other embodiments of the invention can include homophones of Chinese dialects other than Putonghua. In one embodiment, a user whose native tongue is Yue and who does not have complete confidence in the use of Putonghua can use Yue homophones by following input of an alternative homophone character entry with an indication that it was not a Putonghua homophone that was entered but a Yue homophone, and Yue homophones will be displayed for selection.

In other embodiments any number of homophones for any number of dialects or languages are added to the database, including an embodiment in which the primary, or even the only, homophone capability is in a dialect other than Beijing Mandarin (Putonghua). The differences in Chinese dialects are said to be as significant as the differences between French and Italian. Since the national language policy is focused on reducing the communication problems this can create, students in school are taught Putonghua in all parts of the country. Yet pronunciation of Putonghua naturally varies somewhat according to locale, creating problems for phonetic computer-input of text. In one embodiment of this invention, the database is constructed so that the user can rely on the similar sounds of characters in the user's own dialect, rather than having to depend solely on his/her ability to pronounce Putonghua properly. This can be expected to call out a set of homophone characters appropriate to the user's dialect. In such a ‘dialect’ embodiment where both Putonghua pronunciation and that of a second dialect are made available, access of the different dialect's homophone characters is accomplished in the reduced keyboard embodiment by pressing 314, a designated homophone key [9], on the reduced keyboard twice then selecting the dialect prior to entering the homophone character.

In order to increase text entry speed, an experienced user may decide to use alternative homophone entry as the usual entry method for characters which the user finds easier or faster to enter than the desired character. Alternative homophone entry also can be used as a primary means of entry for some or all character entry by designating, in one embodiment, specific characters as the usual input method for each of the various syllables or for each of the sounds that make up the syllables.

The invention's homophone alternative input method is also applicable to Japanese and to Korean, and to any language with homophones, including alphabetic languages.

Input of homophones, near-homophones or non-standard homophones is one of several approaches to supplementary text input methods based on similarities between Chinese characters or Chinese words. Other similarities between characters or words, include meaning, rhyme and character structure can also be useful for Chinese character input. Some such similarities also can be used between alphabetic languages as well as in relation to, or between, Chinese-character-based languages, including Japanese, Korean and both the simplified and traditional characters of Chinese written language. For example, in one embodiment, a user can input an English word, then press a key to request a display of any Chinese words with the same or similar meaning.

In yet another embodiment, the method of alternative input of near-homophones or non-standard homophones also can be useful for displaying alternative interpretations of phonetic input when the desired character is not displayed after input because the user has entered a non-standard pronunciation. For example, if the user uses Pinyin to phonetically enter ‘bā’ (incorrectly) as the pronunciation of the character [symbol] (which is actually rendered in Pinyin as ‘pā’ for the standard Putonghua pronunciation) and fails to see the desired character [symbol] displayed, the user then requests a display of near-homophones. Failing to see the desired character displayed as a near homophone, the user then asks for a display of non-standard homophones, where the user now sees the display of the desired character [symbol] . Designation of ‘non-standard homophones’ in this embodiment is based on common mispronunciations of standard Putonghua.

The above description is illustrative only and is not limiting. The present invention is defined solely by the claims which follow and their full range of equivalents. It is intended that the following appended claims be interpreted as including all such alterations, modifications, permutations, and substitute equivalents as fall within the true spirit and scope of the present invention.

What is claimed is:

1) A method of computer text entry of a desired language unit which utilizes a specified similarity between the desired language unit and one or more alternative language units to enter the desired language unit by entering one of the one or more alternative language units possessing a specified similarity to the desired language unit by:
inputting and displaying one of one or more alternative language units possessing the specified similarity to the desired language unit;
displaying the alternative language units sharing the specified similarity both with the desired character and with the alternative language unit input and displayed; and
selecting the desired language unit from among the alternative language units displayed.

2) The method of claim 1 wherein the language units are Chinese characters.

3) The method of claim 1 wherein the input is non-phonetic input of Chinese characters.

4) The method of claim 1 wherein the specified similarity between the desired language unit and the one or more alternative language units is the pronunciation of the language units.

5) The method of claim 4 wherein the standard pronunciation of the desired language unit is identical to that of the entered one of one or more alternative language units.

6) The method of claim 4 wherein the standard pronunciation of the desired language unit is similar but not identical to that of the entered one of one or more alternative language units.

7) The method of claim 1 wherein the display of the one or more alternative language units sharing a specified similarity with the one of one or more language units input and displayed and the desired language unit is caused by the pressing of a keyboard key after input of the one of one or more language units.

8) The method of claim 1 wherein the display of the one or more alternative language units sharing a specified similarity with the one of one or more language units input and displayed and the desired language unit is caused by pressing a soft key after input of the one of one or more language units.

9) The method of claim 1 wherein the display of the one or more alternative language units sharing a specified similarity with the one of one or more language units input and displayed and the desired language unit is requested making a writing movement not otherwise used for language unit input after input of the one of one or more language units.

10) The method of claim 1 wherein the similarity between the desired language unit and one or more alternative language units is that the desired language unit and the one or more alternative language units is visual.

11) The method of claim 1 wherein the similarity between the desired language unit and one or more alternative language units is that the desired language unit and the one or more alternative language units is meaning.

12) The method of claim 1 wherein the similarity between the desired language unit and the one or more alternative language units is that the desired language unit and the one or more alternative language units are assumed by the user to be Putonghua homophones.

13) The method of claim 1 wherein the similarity between the desired language unit and one or more alternative language units is that the desired language unit and the one or more alternative language units are assumed by the user to be homophones of Chinese dialects other than Putonghua, including Yue.

14) The method of claim 1 wherein the alternative entry of a desired language unit is entry of a language unit of a different language than that of the desired language unit, but assumed to have a similar meaning.

15) The method of claim 1 wherein the input is phonetic input of Chinese characters.

16) The method of claim 2 wherein the Chinese characters are simplified Chinese characters.

17) The method of claim 2 wherein the Chinese characters are traditional Chinese characters.

18) The method of claim 2 wherein the Chinese characters are Korean characters.

19) The method of claim 2 wherein the Chinese characters are Japanese Kanji.

20) The method of claim 14 wherein the desired language unit is a Chinese character and the language unit of a different language are language units of an alphabetic language.
